(19) United States
(12) Patent Application Publication
(10) Pub. No.: US 2003/0127086 A1
(43) Pub. Date: Jul. 10, 2003

(54) Method and apparatus for cutting granite

(76) Inventors: Goetz H. Brauninger, Hambuehren (DE); Ernesto Dossena, Melzo (IT); Michael H. Loh, Stuttgart (DE); Kurt Proske, Dreieich (DE); Matthias Schaub, Milano (IT); Dennis W. Turner, Gahanna, OH (US); Steven William Webb, Worthington, OH (US)

Correspondence Address: Jerry K. Mueller, Jr., Mueller and Smith, LPA, 7700 Rivers Edge Drive, Columbus, OH, 43235, US

(21) Appl. No.: 10/014,547

(22) Filed: Dec. 14, 2001

Related U.S. Application Data
(63) Continuation-in-part of application No. PCT/US00/16797, filed on Jun. 16, 2000.
(60) Provisional application No. 60/139,654, filed on Jun. 17, 1999.

(51) Int. Cl. B28D 1/06

(52) U.S. Cl. 125/16.01; 125/22

(57) ABSTRACT

A horizontal frame saw is equipped with a plurality of generally parallel, spaced-apart blades for cutting granite. Each of the blades has a cutting edge with diamond cutting segments mounted thereon for engaging the granite with a swinging motion for cutting of the granite.

### CROSS-REFERENCE TO RELATED APPLICATIONS

This application is a continuation-in-part of international application serial no. PCT/US00/16797, filed Jun. 16, 2000, which was a continuation-in-part based on U.S. provisional application No. 60/139,654, filed on Jun. 17, 1999, the disclosure of which is expressly incorporated herein by reference.

### FIELD OF THE INVENTION

This invention relates to an apparatus and method for cutting slabs of granite.

### BACKGROUND OF THE INVENTION

Swing-type frame saws have been used commonly for cutting large granite blocks into slabs. These frame saws employ up to 250 steel blades mounted under tension (e.g., 80 kN) on a frame. The frame typically swings about two pivot points. In order to cut granite, the steel blades work together with a slurry containing steel shot and lime dispersed in water. Maximum cutting speeds of 4 cm/hour make this technique slow. For example, cutting a 2-m high block of granite at an average of 3 cm/h downfeed takes almost three days. Both the steel shot process and the time requirements for cutting granite are reasons for the consumption of large amounts of environmentally hazardous steel shot/water/lime slurry. The steel blades also have a useful life of 2-3 blocks on average, which contributes to the costs involved in cutting granite.

U.S. Pat. No. 4,474,154 describes a sawing machine with a triangular straight prism shape frame mounted for pivoting around a horizontal axis with two saw blades. For cutting granite, blades are described as steel ones, sprinkled with water and abrasive grits (like sand, steel shot or silicon carbide) neither ones with diamond segments. Other patents relating to saws include U.S. Pat. Nos. 3,760,789; 2,951,475; 5,150,641; 5,087,261; 5,080,085; 3,554,197; 2,247,215; 4,498,450; and 337,661.

While diamond cutting technology may have been applied to marble in the past, the inherent differences between marble and granite mean that a direct correlation of marble experience and performance will not translate to the cutting (slabbing) of granite. The application of diamond to frame sawing of granite has not been reported in the literature. The following table illustrates the differences between marble and granite.

TABLE 1

| Property* | Marble | Granite |
|---|---|---|
| Density (lb/ft³) | 165-179 | 160-190 |
| Compressive Strength (psi) | 8-27 × 10³ | 13-55 × 10³ |
| Rupture Modulus (psi) | 0.6-4.0 × 10³ | 1.4-5.5 × 10³ |
| Shear Strength (psi) | 1.3-6.5 × 10³ | 3.5-6.5 × 10³ |
| Young's Modulus (psi) | 5-11.6 × 10⁶ | 4-16 × 10⁶ |
| Modulus of Rigidity (psi) | 2-4.5 × 10⁶ | 2-6 × 10⁶ |
| Poisson's Ratio | 0.1-0.2 | 0.05-0.2 |
| Abrasion-Hardness Index | 8-42 | 37-88 |
| (ASIM C-241-51) | | |
| Porositiy (%) | 0.4-2.1 | 0.6-3.8 |

*K. Vikram, Directory of Dimensional Stones, Stone Technology Centre, Jaipur, India (1986)

Basically, granite is a harder material than is marble, so that it would not be unexpected that marble slabbing with diamond bladed saws would not apply to slabbing granite with diamond gang frame saws. It is to the slabbing of granite with horizontal gang frame saws that the present invention is addressed.

### SUMMARY OF THE INVENTION

A horizontal frame saw for cutting granite has a plurality of adjacent and spaced-apart blades for cutting granite. Each of the blades includes diamond cutting segments mounted on a cutting edge thereof for engaging granite with a swinging type motion for cutting slabs of granite.

A method for cutting granite with a horizontal frame saw having a plurality of adjacent and spaced-apart blades for cutting granite is disclosed. Each of the blades include diamond cutting segments mounted on a cutting edge thereof for engaging the granite with a swinging type motion for cutting slabs of granite.

A saw blade for a granite-cutting horizontal frame saw having a plurality of adjacent and spaced-apart blades for cutting granite wherein includes diamond cutting segments mounted on a cutting edge thereof for engaging granite with a swinging type motion for cutting slabs of granite.

Advantages of the present invention include the elimination of conventional steel shot slurries heretofore used in cutting granite with horizontal frame saws. Another advantage is that the diamond-segmented steel blades can be refurbished with new diamond-containing segments after the original diamond segments are worn, and, thus, the steel blades can be re-used many times. A further advantage in using the diamond segments is the expected substantial increases in cutting rates, which may be on the order of at least 2-3 times. Yet an additional advantage is that the use of diamond segmented saw blades in cutting granite with a horizontal frame saw minimizes, if not overcomes, most cut deviations which plague conventional steel blades used with steel shot slurries. These and other advantages will be readily apparent to those skilled in the art based on the present disclosure.

### DESCRIPTION OF THE DRAWINGS

For a fuller understanding of the nature and advantages of the present invention, reference should be made to the following detailed description taken in conjunction with the accompanying drawings, in which:

FIG. 1 is an end view of a diamond segment having a trapezoidal cross-section and blade combination;

FIG. 2 is a simplified side elevational view of an optimized hourglass-shaped horizontal gang saw blade for granite;

FIG. 3 is a simplified side view of a typical frame saw blade illustrating its geometry and the forces that act on it during granite slabbing;

FIGS. 4A, 4B, and 3C illustrates simplified deviations in frame saws;

FIG. 5 is a schematic side-elevational view of a frame saw cutting through a granite block;

FIG. 6 is sectional view taken along line 6-6 of FIG. 5;

FIG. 7 is sectional view taken along line 7-7 of FIG. 5;

FIG. 8 is sectional view taken along line 8-8 of FIG. 7;

FIG. 9 is sectional view taken along line 9-9 of FIG. 8; and

FIG. 10 is a cut-away sectional view of the saw blade and diamond segments.

The drawings will be described in detail below.

### DESCRIPTION OF THE PREFERRED EMBODIMENTS

Segment Composition

In order to replace the conventional method of cutting granite using a swing-type frame saw with a solution employing diamond-containing segments, two requirements must be satisfied. First, the operating cost of the diamond solution must be similar to that of the conventional process. Among other factors, the operating cost is heavily influenced by the life of the segments. Second, the diamond solution must cut the granite slabs such that variations in their thickness are minimized. Typically, thickness variations under 1 mm are deemed acceptable. A suitable composition and design of the abrasive-containing segments is required to achieve the aforementioned requirements.

The composition of a segment is governed by the following factors:

Concentration of diamond used in the segment

Grade of the diamond, which is expresses by the parameters toughness index (TI) and thermal toughness index (TTI). In addition, the presence of a coating on the diamond may be included as a part of the grade.

Size of the diamond, which typically is given by standard mesh sizes.

Relative fractions of the constituents of the bond, which constituents can include, inter alia, refractory metals, metal carbides, and transition metals.

The present invention utilizes a diamond segment composition as follows:

Diamond concentration: 15-40, with the range of 20-35 being preferred (ARE THE UNITS CARATS/MM³?)

Grade of diamond:

TI ranging from between about 26 and 88, with the range of between about 68-88 being preferred

TTI ranging from between about 16 and 82, with the range of between about 45 and 75 being preferred

Additionally, the diamond may be uncoated or coated with at least one layer of a material of composition, MCₓN_{y}, where M is a metal, C is carbon having a first stoichiometric coefficient x, N is nitrogen having a second stoichiometric coefficient y, and 0≦x, and y≦2. The preferred embodiment is a coated crystal with a composition MCₓN_{y} with M referring to transition metals, groups IIIA and IVA metals, or combinations thereof.

Size of diamond: 20- through 80-mesh diamond, with 30- through 70 being preferred.

Bond constituents:

Co or Fe: between about 60% and 100% by weight, with between about 70% and 90% being preferred.

WC: between about 0 and 30 wt-%

Braze material: between about 0 and 20 wt-%, where the braze is one or more of copper, silver, zinc, nickel, cobalt, manganese, tin, cadmium, indium, phosphorus, gold, or palladium

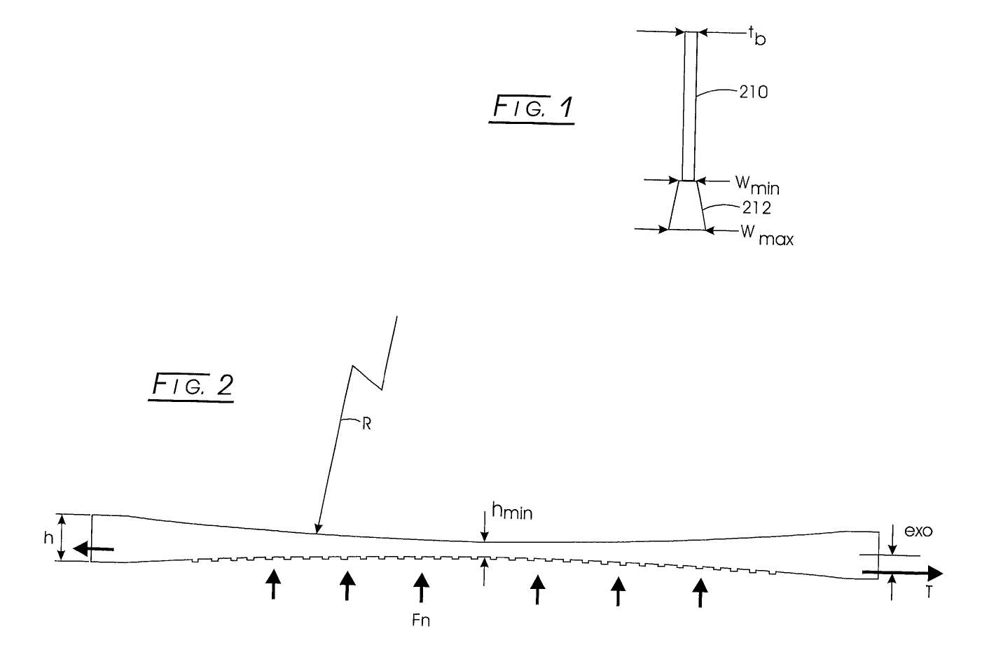

The design of a segment for this invention is intended to prevent development of forces between the blade and the walls of the cut, which can cause the blades to deviate from a straight path as they are lowered into the block. The key requirement of the design is to provide clearance between the blades and cut walls. Consider the end-view of a blade, 210, and segment, 212, combination, schematically illustrated in FIG. 1

The blade thickness is t_{b}. The segment width is given by two terms, wₘᵢₙ and wₘₐₓ, which refer to the minimum and maximum segment widths, respectively. To provide clearance between the blade and cut walls, a portion of the segment width must be greater than or equal to the blade thickness, i.e., wₘₐₓ≧t_{b}.

Any design in which some portion of the segment is wider than the blade will achieve the desired effect. FIG. 1, which illustrates the segment having a trapezoidal cross-section, is for illustrative purposes only, as any number of other shapes can achieve the same effect without necessarily having a trapezoidal cross-section.

The diamond segments that are attached to the cutting edge of steel blades used in conventional swing-type steel shot frame saw applications are sintered powder metallurgy segments. That is, diamond crystals are mixed with one or more metal powders or metal alloy powders, cold-pressed into the desired shape, and then sintered, optionally under pressure. A wide variety of metal powders and alloys can be used in forming diamond segments useful in practicing the present invention, as those skilled in that art will appreciate. Exemplary such metal and alloy powders include, for example, Ni, Cu, Fe, Co, Sn, W, Ti, or an alloy thereof, e.g., bronze, and the like, optionally with ceramic and cermet powders added thereto, such as, for example, WC powder.

In an attempt to improve grit retention, the art coats the diamond particles with carbide-forming transition metals, such as, for example, Mo, Ti, and Cr. Such metals typically are chemically vapor deposited (CVD) or sputtered onto the surfaces of the diamond grit. Examples of such coatings and processes for the deposition thereof are disclosed in U.S. Pat. Nos. 3,465,916, 3,650,714, 3,879,901, 4,063,907, 4,378,975, 4,399,167, and 4,738,689; U.S. Reissue No. 34,133; and EP-A79/300,337.7. It has been reported, however, that these coatings may be oxidized and, depending upon the carbide formed, may be brittle. In response, proposals have been made to use a carbide-forming metal layer as part of a multi-layer coating system. As is described in U.S. Pat. Nos. 3,929,432, 5,024,680, 5,062,865, and 5,232,469, such multi-layer coating systems generally involve the vapor-phase deposition of an inner layer of a thin (0.05 to 15 micron thick) carbide-forming metal, and an outer layer of a more corrosion resistant metal, such as Ni or Cu, for protecting the inner layer from oxidation. Newer coating systems appear in the art periodically and similarly can be used to advantage in the present invention.

For purposes of the present invention, then, use of any and all technology related to the manufacture of diamond segments can be practiced to advantage in the cutting of granite with swing-type saw assemblies whose blades have cutting edges fitted with such diamond segments.

The diamond segments can range in dimension from about 5 to 100 mm in length by about 5 to 30 mm in height by about 4 to 8 mm in thickness, with segments of about 20 mm length by about 11.5 mm in height by about 6 mm in thickness presently being preferred. The diamond segments should be thicker than the thickness of the blade. The diamond segments can have any convenient shape including, for example, rectangular, tapered, sandwich, etc., as discussed above.

Blade Design

Conventional blades used in horizontal frame saws typically are rectangular pieces of warm-rolled C70 steel having dimensions as follows: length of approximately 3 m, width of approximately 5 mm, and height of 90-120 mm. These blades also are prone to deflection when used to slab granite with fixed diamond segments mounted on their cutting edge. This is due to the increased blade forces with use of hard, fixed segments rather than loose, soft abrasives in conventional frame saws. Increased forces create new deflections that can lead to cuts deviating from a straight path, resulting in slabs having a large thickness variation, non-uniform blade and segment wear and blade flexing, buckling and increased rate of blade fracture. Slabs having thickness variation>1 mm cannot be sent to subsequent indexing and polishing steps and must be scrapped. Thus, new methods of stiffening frame saws, and designing the segments, to manage the higher forces with fixed diamond segments, are required.

Another aspect of the present invention, then, involves methods to improve a blade's resistance to deflection due to increased forces with fixed hard segments, thereby reducing the propensity for cut deviation, yet still maintain higher cutting rates and lower blade wear rate, when slabbing granite with diamond segments mounted on its cutting edge.

In particular, finite element analysis has revealed an hourglass-shaped blade design (see FIG. 2) that can be optimized by two different approaches. The first approach provides minimum lateral deflection using a maximum stress of less than 350 MPa and the second approach maximizes the standard deviation of lateral deflection while keeping 350 MPa as an upper limit of the maximum stress. Both approaches yield a lateral deflection of less than 1.00 mm; however, the second approach produces better optimization results.

These hourglass blade optimization efforts can be summarized below:

| | | |
|---|---|---|
| Thickness | 5.5 | mm |
| Height | 204 | mm |
| Min. height | 68 | mm |
| Pre-Tension | 90 | kN |
| Eccentricity of Pre-Tension | 0 | |
| Normal Cutting Force 1331 N | | |

With these design numbers, lateral deflection is 0.225 mm (σ=0.118 mm) and maximum stress of 256 MPa (σ=10.6 MPa).

Analysis of Frame Saws

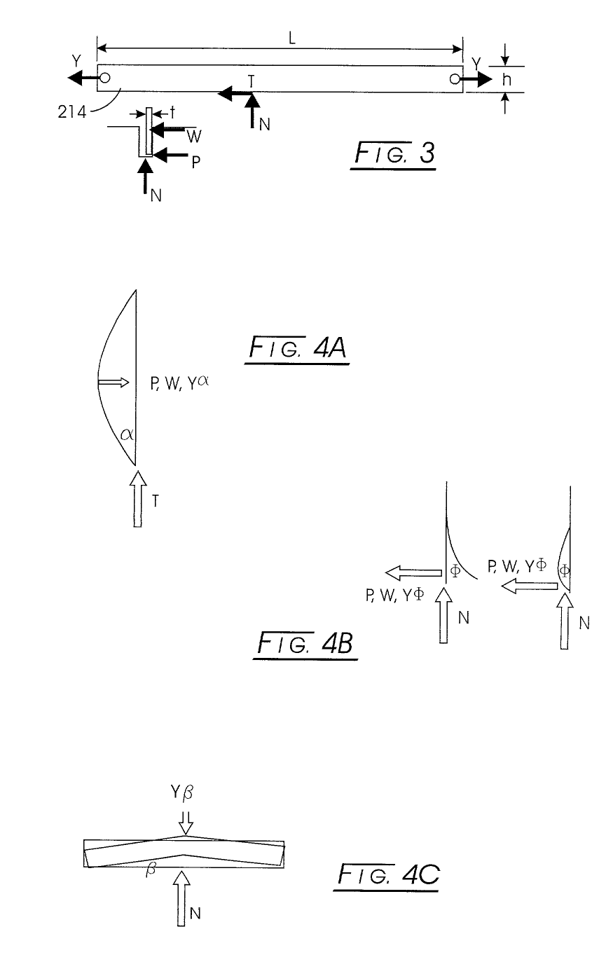

Consider a blade, 214, with length L, height h, and thickness, t fixed at a point h/2 and L=0, 1 at each end, as illustrated in FIG. 3. External blade forces include normal, N; tangential, T; wall contact, W; friction, P; and tension, Y; as applicable to the specific situation, i.e., kinematics and stone-blade reactions.

Unlike constant-speed circular saws, a frame saw undergoes periodic acceleration in tangential and normal direction (for pendular motion). Blade forces are transient. T is a balance between torque in the drive motor, stone friction and blade-frame inertia. When blade 214 is accelerating in the cut, T is maximum, inertia is minimum (v=0) and friction maximum (static). Once blade 214 accelerates to constant velocity, blade forces reduce. Blade 214 is most susceptible to deformation during acceleration. High blade force is mitigated by kinematics, i.e., lifting the blade off the stone during acceleration.

Average shaft power is Tv. Normal force N is the reaction of downfeed and force T from the details of the blade-stone-slurry contact and wear rates.

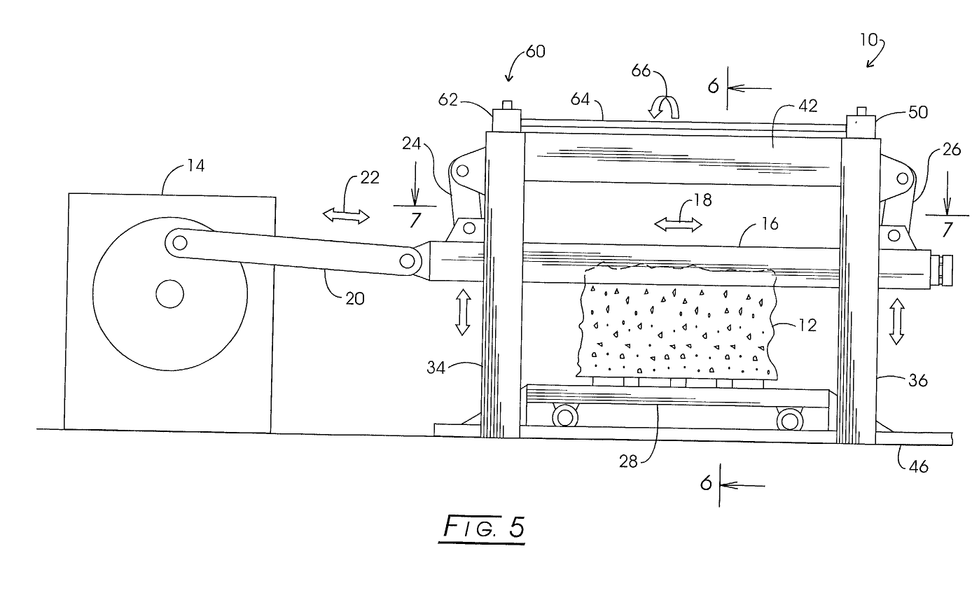

There are 3 independent modes of unstable bending deflection shown in FIGS. 4A-C exaggerated for clarity: bowing (a) in the tangential direction, flexing (f), and bending (b) in the normal direction. Bow and flex are forms of unstable deformation referred to as buckling. Rigid fixturing at h/2, L=0, 1 is presumed. Flex can occur with slip at the cutting surface or no slip (FIG. 4B), depending on P relative to N, W, and Y.

Tension, Y; friction, P; and wall force, W; act against deflection depending on the sine of the angle of deflection. For small deflections, sin f˜f. Thus, assuming all forces are uniform, the effectiveness of the restoring force depends on a characteristic length. If Y=0 (no tension), deflection is limited by wall contact, W, and contact friction, P. Wall contact leads to wall wear and as a means of limiting blade deflection is highly undesirable. The blade wall is much softer than the hard segment. Wall wear leads to “knife-edging”, high power, high forces, and high wear rate. In many deep cuts wall wear is unavoidable and hardening the wall is necessary, and costly (so-called “gauge protection”).

With W=Y=0, deflection is limited by friction P, where P=mN, and m is a coefficient of friction between stone-debris-fluid and the hard segment. For a low-friction saw, e.g., high-speed circular saws, m is small. Only blade stiffness and intrinsic tension (e.g., defects in manufacture) limit blade deflection. For high-friction saws (e.g., frame saws) P can be effective against slip, but marginally against flex depending on where the fixture is located. Friction is sensitive to cutting point protrusion or relief of the cutting surface (stone and segment), speed and presence of lubricants (rolling debris, fluids, surfactants).

Small deflections may be estimated by the ratio of bending moment or buckling load against stiffness. Stiffness is from material and geometry, parameter EI, where E is the modulus of the blade material and I the moment of inertia in the bending plane. For rectangular cross-sections, I=bx³/12, where b is base dimension and x is thickness acting against the moment of the fixed plane in bend at the centroid.

Bowing: b=height, x=thickness,

Flexing: b=length, x=thickness,

Bending: b=thickness, x=height.

I is smallest in bowing. In the absence of tension, friction, or wall force, bowing is assured. Stiffness is augmented by tension and proportional to Yk²/2, where k is the characteristic dimension;

Bowing: k=length,

Flexing: k=height,

Bending, k=length.

Tension is most effective against bowing and bending. Practically, tension Y is essential for long blades. Y usually approaches material yield, creating fatigue and finite blade life at stress concentrations at the fixture (ignoring wall wear).

The consequences of deflection are all bad. Bow will fatigue and fracture the blade or stall the machine. Bending will fracture the blade. Flex (with or without slip) causes cut deviation, wall and non-uniform segment wear. For a best-case frame saw, i.e., stable, high friction, blade with no stalling, no blade fracture, no slip, and no wall contact, the major deviation problem is flex and non-straight cuts (mm/m-cut).

There also is shear on the blade acting against fixturing, which is ignored in the analysis of deflection under the assumption that blade fatigue and buckling instability is dominated by bending tension. This simple analysis ignores distributions, non-uniform, asymmetric, and concentrations of forces and moments.

Methods of Improving Frame Saw Performance

The key to frame saw design with hard diamond segments and hard segment-stone contact, is to redistribute the new, increased blade forces against stiffened parts of the machine. This allows the higher cutting rate from higher forces with nominal deflections, cut deviations, blade fatigue, and lower segment wear rate.

A prior art 5 mm-thick frame saw blade, cutting with steel shot and lime at 2.6 cm/min downfeed, runs with normal force per blade of 220 N, tangential force per blade of 1420 N (0.37 kW/blade), and tension of 62 kN per blade. Such a saw blade produces acceptable deflection, deviation, blade wear, and stone cut surface quality. The same frame saw fitted with diamond segments in accordance with the present invention (no steel shot) will cut at 300% the rate (3×) and will run with higher blade forces.

In one limiting case with the total force increasing by 3×, slabbing will proceed normally trying to flex the blade. This will cause major cut deviation; however, machine power will be unchanged. In the other limiting case, all of the 3× force will be in the tangential direction, trying to bow the blade. Machine power basically triples, but cut deviation is unchanged. The blade, however, may contact the wall causing major increase in friction, stalling the machine and/or fracturing the blade.

This aspect of the present invention is for a novel design process that allows the blade manufacturer to optimize its frame saws for hard diamond-containing segments in the limit of increased blade normal and/or tangential forces. Included in this aspect of the invention is design of the hard segments (e.g., mesh, concentration, composition, grade, as discussed above) to manipulate the new higher forces, design of the blade and fixtures, and design of the lubrication system.

Blade Dimensions (All Other Variables Held Constant)

All 3× force N: blade thickness must increase from 5 mm to 7.2 mm

All 3× force T: tension must increase to 180 kN (blades will fracture)

An increase in tension to only 90 kN will permit use of a 5 mm blade, but the cutting rate will limited to 1.5× or 50% increase (T=2200 N).

Blade Fixturing

Referring to FIG. 3, fixturing the blade at the center point (h/2) constrains flex. Locating the fixture closer to the bottom of the blade increases stiffness by moving the center of the tension closer to the deflecting force, thus reducing the flex. This fixturing would support the case where all 3× forces on the blade are diverted normal, with normal stiffness increased by fixturing.

Blade Material

To improve blade material stiffness and reduce inertia, the manufacturer can use higher modulus (E), lower weight blades, e.g., MMC (metal-ceramic composite) or fiber-reinforced resins. Impact and abrasion resistance can be increased with fillers. This would support the case where the majority of new blade force is diverted normal.

Segment Design

A segment is designed both to improve wear resistance of the cutting edge of the blade, and to create and distribute increased blade forces in a manner most suited to the particular machine. The key design feature is steady-state cutting point protrusion of the segment against the stone. This is achieved with correct selection of the gradient between cutting point and binding matrix hardness/toughness. When that gradient is large, protrusion is high, as is the normal blade force. When that gradient is small, protrusion is low, as is the normal blade force.

All 3× force N: maximum protrusion: use of hard, coarse-mesh, tough cutting point (e.g., UHG (ultra high grade) diamond) in a soft metal bond.

All 3× force T: zero protrusion: nominally hard point and matrix phase, from hard, super-fine-mesh, tough diamond in hard cermet or ceramic matrix.

Horizontal Gang Frame Saw Construction

Spacing of the diamond segments along the blade edge can be essentially continuous (e.g., 20 mm center-to-center for a 20 mm length diamond segment) on up to about 400 mm (center-to-center) or more, depending, of course, on the stroke length of the particular swing-type saw. For the 20 mm by 11.5 mm by 6 mm diamond segments reported in the Examples, 85 mm center-to-center spacing is being used.

The diamond segments may be attached to the blade edge of the saw blades by brazing, which is the typical method for attachment of diamond segments to metal tools and parts. Such diamond segment brazing operation is conventional and well known in this art. Of course, such brazing operation must be conducted under conditions (e.g., temperature) preclusive of appreciably damaging the diamond crystals in the diamond segment to such an extent that they suitability in the granite cutting/slabbing operation is compromised. Too, the temperature during the brazing operation also must not damage the blade or otherwise comprise its integrity and suitability for cutting granite. It should be recognized, however, that conventional brazing techniques might be too slow to deliver the volume of segments brazed on blades in relation to the needs of the present invention.

Laser welding, then, combines the advantages of being a faster method to attach the segment to the blade and being more accurate in segment alignment. Laser welding, in its most common form, occurs when the laser is used as an intense energy source to selectively heat materials to a point between their melting and vaporizing temperatures. Once molten, the materials are allowed to alloy and then resolidify in a controlled atmosphere. The result is a reliable, oxide-free weldment. Unlike many of the other joining processes, the overall size and depth-to-width ratio of the weld nugget can be custom tuned in laser welding. By adjusting various parameters such as the laser energy and focal point position, one can create weld ratios ranging from wide and shallow to narrow and deep. In most cases the part geometry dictates this ratio.

Many manufacturers currently use laser welding (typically a CO₂ or a YAG laser) to attach abrasive bearing segments to saw blade cores, although the initial investment in laser equipment is more expensive than brazing equipment. Welding is required in applications that necessitate high strength segment attachment (i.e., dry sawing) where high temperatures melt braze alloys and segment detachment is a safety issue. When laser welding capability is acquired by necessity for the production of dry sawing tools, it is commonly applied to the production of all other types for the benefits of superior segment attachment, higher production rates and less thermal influence on areas adjacent to the welded interface. Further information on such laser welding can be found in U.S. Pat. Nos. 4,689,919 and 4,727,778; and at the following websites:

www.laserage.com/welding.htm,

www.drfritsch.de/english/products/brazing/idrreport.htm, and

www.ailu.org.uk/applications/rof06.htm.

Referring now to the swing-type frame saw itself, FIG. 5 is schematic side-elevational view of a frame saw, 10, cutting through a granite block, 12. Swing frame saw 10 is powered by a motor, 14, whose rotational movement is translated into horizontal movement of a blade frame assembly, 16 (see arrow 18) through an arm 20 (see arrow 22). Blade frame assembly 16 retains a plurality of saw blades (as described above), which cut slabs of granite from granite block 12. Blade frame assembly 16 is mounted to frame saw 10 by pivot arm assemblies, 24, 26, 28, and 30 (see also FIGS. 2 and 3), which, when powered by motor 14, moves in a swinging motion to cut granite block 12 with the plurality of saw blades mounted therewithin. Blade frame assembly, and consequently the blades retained thereby, typically have swing-radius of about 1-2 m. The “stroke” or swing-amplitude in most swing-type frame saws is between 0.4 and 1 m. Granite block 12 is conveyed into a cutting station and away therefrom by a wheeled cart, 32. Cart 32 also carries block 12 while it is being sawed.

Four vertical posts, 34, 36, 38, and 40 (see FIGS. 5-8), respectively, carry pivot assemblies 24-30. These vertical posts are connected at their upper ends by beams, 42, 44 (see FIG. 2), and two other beams not shown in the drawings. Vertical posts 34-40 are mounted to a base platform, 46, upon which cart 22 drives to place block 12 in the cutting station for its cutting.

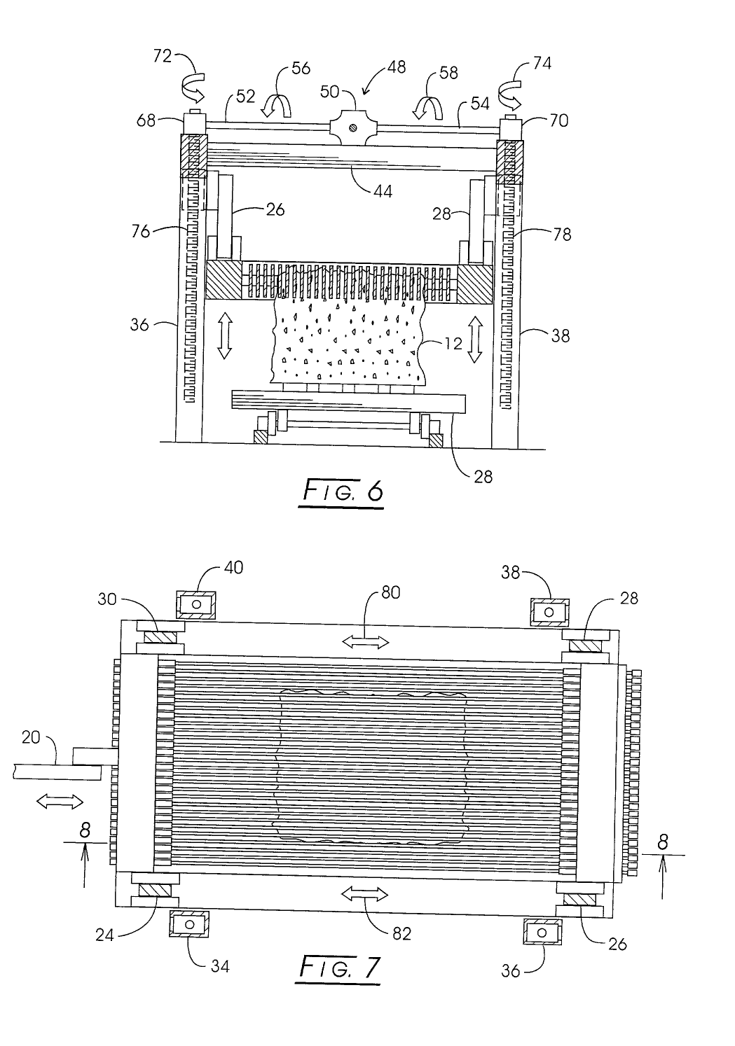

Affixed to vertical posts 36 and 38 is a downfeed assembly, 48, which consists of a motor, 50, which rotates a pair of shafts, 52 and 54, which rotate according to arrows 56 and 58. Affixed to vertical posts 34 and 40 is a downfeed assembly, 60, which consists of a motor, 62, and a pair of rotating shafts (not shown in the drawings). Motor 50 and gear assembly 62 are synchronized by a rotating shaft, 64, which rotates in the direction of arrow 66. This synchronization ensures that blade frame 16 will be fed downwardly in a horizontal plane for even cutting of granite block 12. Shafts 52 and 54 are connected, respectively, to gear assemblies, 68 and 70, which provide rotation as shown by arrows 72 and 74 to threaded rods, 76 and 78, respectively. A similar arrangement (not shown in the drawings) exists for downfeed assembly 60. Threaded rods, 76 and 78, in turn, carry pivot assemblies 26 and 28 with pivot assemblies 24 and 30 being carried by similar threaded rods disposed within vertical posts 34 and 40. The downfeed rate of blade frame 16 is determined by the speed of motors 50 and 62, which can be controlled by a feedback loop that senses the rate of cutting of granite block 12. Arrows 80 and 82 in FIG. 7 show the swinging motion or arc of blade frame 16.

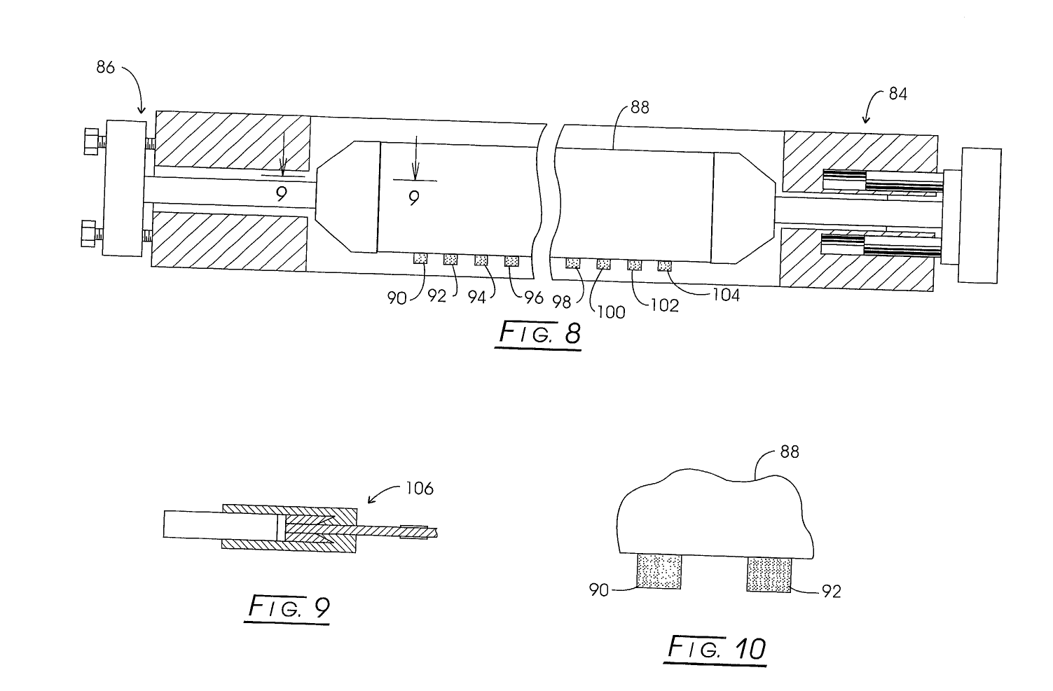

Finally, the plurality of blades held by blade frame 16 are tensioned by hydraulic cylinder assemblies, such as illustrated by a cylinder assembly, 84, and by a tensioning assembly, 86, in FIG. 8. Due to the close spacing of the blades in blade frame 16, adjacent blades often are connected to cylinders, which are alternatingly disposed at higher and lower vertical elevations. Of importance, however, is a steel blade, 88, which is representative of the plurality of blades retained by blade frame 16. Mounted along the lower cutting edge of blade 88 are diamond segments, 90-104, which can be greater or lesser in number than the eight illustrative segments depicted in FIG. 8. Such diamond segments permit much-improved cutting of granite, as will be exemplified in the Example, which follows this description of the invention. The retention of blade 88 within blade frame 16 is illustrated in FIG. 9.

An enlarged view of segments 90 and 92 is illustrated in FIG. 11. Depending upon the thickness of blade 88, diamond segments 90-104 can range in thickness from about 2 to 8 mm. Blade 88 will have a height that ranges from about 50 to 500 mm and usually is rectangular in shape; although, hourglass (double concave) has been shown to optimize lateral deflection. Other possible blade shapes include, inter alia, convex/straight, concave/straight, double convex, and convex/concave, and like shapes. A distinct advantage of the present invention is that steel blades used in conventional swing-type steel shot frame saw applications can be retrofitted with diamond-containing segments in order to cut/slab granite.

While the invention has been described with reference to a preferred embodiment, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In this application all units are in the metric system and all amounts and percentages are by weight, unless otherwise expressly indicated. Also, all citations referred herein are expressly incorporated herein by reference.

### EXAMPLE 1

A swing-type granite frame saw with twenty-five sets of 2 to 14 blades each was tested in class 3/4 granite (Rosa Sardo). The test demonstrated the ability to saw granite with a swing-type gang saw using diamond segments. All 25 sets of two to 14 blades cut into the granite. A maximum depth of cut of 1,200 mm was achieved. A downfeed of 6.5 cm/h (the machine maximum downfeed rate) was possible as compared to 4 cm/h max for a steel shot operation.

According to the test details, 25 sets of two to fourteen blades each were prepared according to DOE specifications. Factors were crystal grade (Grade 970 to Grade 910), size (25/30 mesh to 70/80 mesh), concentration (5 conc. to 50 conc.), coated vs. uncoated crystals, segment bond (15% Bronze (80/20 Cu/Sn) in coarse cobalt, 100% coarse cobalt, 5-50% WC in fine cobalt), number of segments (15-40), saw blades (dimensions 3.7 m long×5 mm thick×100 mm high, and 3.85 m long×3.5 mm thick×180 mm high), and blade tension (80 kN and 100 kN). Centerpoints and extreme conditions were included in the test. Segments (dimensions 6 mm×20 mm×11.5 mm) were prepared and brazed to the steel saw blades. The segments were distributed with even pitch, as well as with uneven pitch, resulting in an effective cutting length of 3 m.

The granite cut was class 3/4 Rosa Sardo (dimensions: 2.85 m length×1.8 m height×2 m width, planar top surface to create equal conditions for each cut). The saw used was a swing-type, steel shot granite gang-saw operating at 72 cycles per minute with a 440 mm stroke. These operation conditions result in an average cutting speed of 1.1 m/s (with a maximum around 2 m/s).

Each trial run was started with slow a downfeed (1-3 cm/h) until all the segments were fully engaged in the block (1-3 hours). The downfeed then was increased to 4-6.5 cm/h until some segments were worn.

The evaluation was performed with a representative number of segments of each blade, which were measured to determine segment wear. These segments were kept for detailed evaluation. The “depth of cut” was measured at 3 points (front, center, and back) in each cut.

The depth of cut by the segments and the segment wear were measured, and wear performance (WP) was calculated. Analysis of the WP results indicated the following:

diamond concentration is a significant WP factor with a higher concentration providing better wear performance;

coating of the diamond crystals used to form the diamond segments also seems to be a significant factor for WP; and

size and grade are less significant factors for WP.

Under Extreme Conditions:

very high diamond concentrations (i.e., >50 conc.) prevented bond wear and enabled the deepest cuts (1200 mm), but cut deviation was significant (outside specification limit); and

very low diamond concentrations (i.e., <10 conc.) resulted in the straightest cuts (i.e., no cut deviation), but segment wear was significant such that the segment was spent after 1200 mm cut depth

Vibrations during beginning stages of cut increase the segment wear.

Steel blades can be refurbished with diamond containing segments after they are worn and, thus, can be used many times. In addition, the use of diamond segments provides possibly substantial increases in cutting rates, improvements may be on the order of at least 2-3 times, possibly even up to 50 cm/h. The resulting slabs can be cut within desired specification limits.

### EXAMPLE 2

Segments containing diamond were manufactured by blending the bond constituents with diamond, then densifying the mixed powders into solid bodies via hot pressing. These segments had the following properties.

TABLE 2
Composition

| | |
|---|---|
| Concentration | 30 |
| TI | 68 |
| TTI | 66 |
| Coating | TiC, with some Cr substituting for the Ti |
| Diamond Size | 50/60-mesh |
| Bond constituents | 80 wt % Co |
| | 20 wt % WC |

TABLE 3
Shape

| | | |
|---|---|---|
| Wₘᵢₙ | 5.5 | mm |
| Wₘₐₓ | 6.5 | mm |
| t_{b} | 5 | mm |

25 segments were brazed with uniform spacing to a frame saw blade having a thickness of 5 mm. A series of such blades were mounted onto a horizontal gang frame saw to cut a block of Rosa Sardo granite.

After sufficient penetration into the block, the cutting operation was halted to assess the segment life and the variation in thickness of the slabs. Segment life was determined by measuring the mean segment height reduction due to the cutting operation, which was then divided into the surface area of slabs generated in the cut. Thickness variation of the slabs was assessed by measuring the thickness of each slab in four locations evenly distributed along the slab height both on its front and back.

The mean segment life for this cut was calculated to be 4.79 m²/mm. Results for the slab thickness variation are given in Table 5.

TABLE 5
Slab Thickness Measurements

| | Slab Thickness (mm) | | | | | | | | Maximum | | |
|---|---|---|---|---|---|---|---|---|---|---|---|
| | Front | | | | Back | | | | Thickness (mm) | | |
| Slab # | 1 | 2 | 3 | 4 | 1 | 2 | 3 | 4 | Front | Back | Both |
| 1 | 21.25 | 21.34 | 21.46 | 21.86 | 21.33 | 21.27 | 21.47 | 21.78 | 0.61 | 0.51 | 0.61 |
| 2 | 21.84 | 21.67 | 21.64 | 21.69 | 22.05 | 21.92 | 22.02 | 21.81 | 0.20 | 0.24 | 0.41 |
| 3 | 22.06 | 22.08 | 21.98 | 21.93 | 21.91 | 21.87 | 21.86 | 21.95 | 0.15 | 0.09 | 0.22 |
| 4 | 21.94 | 21.76 | 21.69 | 21.61 | 21.76 | 21.81 | 21.67 | 21.64 | 0.33 | 0.17 | 0.33 |
| 5 | 21.92 | 22.07 | 21.88 | 21.77 | 21.57 | 21.68 | 21.70 | 21.55 | 0.30 | 0.15 | 0.52 |
| 6 | 22.46 | 21.80 | 21.84 | 21.63 | 21.90 | 22.00 | 22.10 | 21.98 | 0.83 | 0.20 | 0.83 |
| 7 | 21.75 | 21.74 | 21.80 | 22.06 | 21.46 | 21.40 | 21.33 | 21.67 | 0.32 | 0.34 | 0.73 |
| 8 | 21.87 | 21.64 | 21.69 | 21.88 | 21.82 | 21.62 | 21.52 | 21.60 | 0.24 | 0.30 | 0.36 |
| 9 | 21.59 | 21.82 | 21.50 | 21.41 | 21.35 | 21.20 | 21.26 | 21.10 | 0.41 | 0.25 | 0.72 |
| 10 | 21.88 | 22.33 | 22.30 | 22.26 | 21.85 | 21.80 | 22.06 | 21.84 | 0.45 | 0.26 | 0.53 |

Thickness variation, described as the difference between the maximum and minimum thickness on a given slab, was below 1 mm for all slabs. The mean value of the thickness variation for the data presented is 0.53 mm, well within the acceptable limit of thickness variation.

What is claimed is:

1. A horizontal frame saw equipped with a plurality of generally parallel, spaced-apart blades for cutting granite, wherein each of the blades has a cutting edge with diamond cutting segments mounted thereon for engaging the granite with a swinging motion for cutting of the granite.

2. The horizontal frame saw of claim 1, wherein said blades have a width and said diamond cutting segments have a width, the width of the said diamond cutting segments being greater than the width of said blades.

3. The horizontal frame saw of claim 1, wherein said diamond cutting segments are comprised of diamond particles bonded together by a metal or alloy.

4. The horizontal frame saw of claim 3, wherein said metal or alloy is one or more of Ni, Cu, Fe, Co, Sn, W, Ti, or an alloy thereof.

5. The horizontal frame saw of claim 4, wherein said diamond cutting segments further contain between about 60% and 100% by weight of Co or Fe, and between about 0 and 30% WC.

6. The horizontal frame saw of claim 3, wherein said diamond particles are coated with a layer of a material of composition, MCₓN_{y}, where M is a metal, C is carbon having a first stoichiometric coefficient x, N is nitrogen having a second stoichiometric coefficient y, and 0≦x, and y≦2.

7. The horizontal frame saw of claim 6, wherein M is one or more of a transition metal, a Group IIIA metal, or a Group IVA metal.

8. The horizontal frame saw of claim 3, wherein said diamond particles range in size from about 20 mesh to 80 mesh.

9. The horizontal frame saw of claim 8, wherein said diamond particles range in size from about 30 mesh to 70 mesh.

10. The horizontal frame saw of claim 3, wherein said diamond cutting segments have a diamond concentration of between about 15 and 40.

11. The horizontal frame saw of claim 10, wherein said diamond cutting segments have a diamond concentration of between about 15 and 40.

12. The horizontal frame saw of claim 1, wherein said diamond cutting segments range in size from about 5 to 100 mm in length by 5 to 30 mm in height by 4 to 8 mm in thickness.

13. The horizontal frame saw of claim 1, wherein said diamond cutting segments range in spacing from being in edge-to-edge contact to about 400 mm center-to-center.

14. The horizontal frame saw of claim 1, wherein said diamond cutting segments are brazed onto the cutting edge of said blades.

15. The horizontal frame saw of claim 3, wherein said diamond in said diamond cutting segments has a toughness index ranging from between about 26 and 88.

16. The horizontal frame saw of claim 3, wherein said diamond in said diamond cutting segments has a toughness index ranging from between about 20 and 35.

17. The horizontal frame saw of claim 3, wherein said diamond in said diamond cutting segments has a thermal toughness index ranging from between about 66 and 82.

18. The horizontal frame saw of claim 16, wherein said diamond in said diamond cutting segments has a thermal toughness index ranging from between about 45 and 75.

19. A method for cutting granite with a horizontal frame saw having a plurality of adjacent and spaced-apart blades wherein said blades have a cutting edge for engaging said granite for its cutting, which comprises engaging the granite with the cutting edges of said blades, wherein each of the blades includes diamond cutting segments mounted on the cutting edge thereof.

20. The method of claim 19, wherein said blades have a width and said diamond cutting segments have a width, the width of the said diamond cutting segments being greater than the width of said blades.

21. The method of claim 19, wherein said diamond cutting segments are comprised of diamond particles bonded together by a metal or alloy.

22. The method of claim 21, wherein said metal or alloy is one or more of Ni, Cu, Fe, Co, Sn, W, Ti, or an alloy thereof.

23. The method of claim 22, wherein said diamond cutting segments further contain between about 60% and 100% by weight of Co or Fe, and between about 0 and 30% WC.

24. The method of claim 21, wherein said diamond particles are coated with a layer of a material of composition, MCₓN_{y}, where M is a metal, C is carbon having a first stoichiometric coefficient x, N is nitrogen having a second stoichiometric coefficient y, and 0≦x, and y≦2.

25. The method of claim 24, wherein M is one or more of a transition metal, a Group IIIA metal, or a Group IVA metal.

26. The method of claim 21, wherein said diamond particles range in size from about 20 mesh to 80 mesh.

27. The method of claim 26, wherein said diamond particles range in size from about 30 mesh to 70 mesh.

28. The method of claim 21, wherein said diamond cutting segments have a diamond concentration of between about 15 and 40.

29. The method of claim 28, wherein said diamond cutting segments have a diamond concentration of between about 15 and 40.

30. The method of claim 19, wherein said diamond cutting segments range in size from about 5 to 100 mm in length by 5 to 30 mm in height by 4 to 8 mm in thickness.

31. The method of claim 19, wherein said diamond cutting segments range in spacing from being in edge-to-edge contact to about 400 mm center-to-center.

32. The method of claim 19, wherein said diamond cutting segments are brazed onto the cutting edge of said blades.

33. The method of claim 21, wherein said diamond in said diamond cutting segments has a toughness index ranging from between about 26 and 88.

34. The method of claim 21, wherein said diamond in said diamond cutting segments has a toughness index ranging from between about 20 and 35.

35. The method of claim 21, wherein said diamond in said diamond cutting segments has a thermal toughness index ranging from between about 66 and 82.

36. The method of claim 34, wherein said diamond in said diamond cutting segments has a thermal toughness index ranging from between about 45 and 75.

37. The method of claim 19, wherein said diamond cutting segments are mounted to said blades by brazing or laser welding.

38. A saw blade for a horizontal frame saw equipped with a plurality of generally parallel, spaced-apart blades for cutting granite, said saw blade having a cutting edge, which has diamond cutting segments mounted thereon for said diamond cutting segments to engage granite with a swinging type motion for cutting slabs of granite.

39. The method of claim 38, wherein said blades have a width and said diamond cutting segments have a width, the width of the said diamond cutting segments being greater than the width of said blades.

40. The method of claim 38, wherein said diamond cutting segments are comprised of diamond particles bonded together by a metal or alloy.

41. The method of claim 40, wherein said metal or alloy is one or more of Ni, Cu, Fe, Co, Sn, W, Ti, or an alloy thereof.

42. The method of claim 41, wherein said diamond cutting segments further contain between about 60% and 100% by weight of Co or Fe, and between about 0 and 30% WC.

43. The method of claim 40, wherein said diamond particles are coated with a layer of a material of composition, MCₓN_{y}, where M is a metal, C is carbon having a first stoichiometric coefficient x, N is nitrogen having a second stoichiometric coefficient y, and 0≦x, and y≦2.

44. The method of claim 43, wherein M is one or more of a transition metal, a Group IIIA metal, or a Group IVA metal.

45. The method of claim 40, wherein said diamond particles range in size from about 20 mesh to 80 mesh.

46. The method of claim 45, wherein said diamond particles range in size from about 30 mesh to 70 mesh.

47. The method of claim 40, wherein said diamond cutting segments have a diamond concentration of between about 15 and 40.

48. The method of claim 47, wherein said diamond cutting segments have a diamond concentration of between about 15 and 40.

49. The method of claim 38, wherein said diamond cutting segments range in size from about 5 to 100 mm in length by 5 to 30 mm in height by 4 to 8 mm in thickness.

50. The method of claim 38, wherein said diamond cutting segments range in spacing from being in edge-to-edge contact to about 400 mm center-to-center.

51. The method of claim 38, wherein said diamond cutting segments are brazed onto the cutting edge of said blades.

52. The method of claim 40, wherein said diamond in said diamond cutting segments has a toughness index ranging from between about 26 and 88.

53. The method of claim 40, wherein said diamond in said diamond cutting segments has a toughness index ranging from between about 20 and 35.

54. The method of claim 40, wherein said diamond in said diamond cutting segments has a thermal toughness index ranging from between about 66 and 82.

55. The method of claim 54, wherein said diamond in said diamond cutting segments has a thermal toughness index ranging from between about 45 and 75.

56. The method of claim 38, wherein said diamond cutting segments are mounted to said blades by brazing or laser welding.
